(19) United States
(12) Patent Application Publication
(10) Pub. No.: US 2008/0271845 A1
(43) Pub. Date: Nov. 6, 2008

(54) Process for Temporary Fixing of a Polymeric Layer Material on Rough Surfaces

(75) Inventors: Klaus Keite-Telgenbuscher, Hamburg (DE); Nils Utesch, Hamburg (DE); Stephan Zollner, Buchholz/ Nordheide (DE); Thorsten Krawinkel, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, Hamburg (DE)

(21) Appl. No.: 12/094,179

(22) PCT Filed: Nov. 6, 2006
(86) PCT No.: PCT/EP06/68140

§ 371 Date: Jul. 10, 2008

(30) Foreign Application Priority Data
Nov. 21, 2005 (DE) 102005055769.4

(51) Int. Cl. B32B 37/14

(52) U.S. Cl. 156/307.1

(57) ABSTRACT

Process for temporary fixing of a polymeric layer material on rough surfaces, wherein the polymer layer material encompasses at least one viscoelastic layer, wherein the process involves laying the layer material on the rough surface, introducing energy in order to lower the viscosity of the at least one viscoelastic layer, in such a way that flow onto the rough surface takes place, and the layer is crosslinked in such a way as to produce a layer which has at least some elastomeric character and which at least to some extent wets the rough surface.

This application is a 371 of PCT/EP2006/067140, filed Nov. 6, 2006, which claims foreign priority benefit under 35 U.S.C. § 119 of the German Patent Application No. 10 2005 055 769.4 filed Nov. 21, 2005.

The invention relates to a process for the temporary fixing of a polymeric layer material on rough surfaces, the layer material being especially suitable for fixing devices with highly structured surfaces or to highly structured substrates, and preferably having a very high temperature resistance.

The layer material is intended more particularly to make it easier to manufacture thinner wafers of the kind used in the fabrication of semiconductor products. The intentions are that the wafers should be preferably more reliable to process, and/or that the necessary manufacturing cost and complexity associated with the fabrication of semiconductor components, circuits, sensors and/or other semiconductor products should be reduced and/or made less expensive, and/or the use of laser beam cutting techniques should be made possible or facilitated, and/or more particularly that the coating and/or patterning of the backside of the thinned wafer should be made possible or facilitated, and/or that the risk of fracture and/or of mechanical damage should be reduced.

Oftentimes there is a technical need to provide surfaces with temporary covering in order to support them or protect them for transit or downstream process steps. One widespread method, for example, is to cover parts of autos with an adhesive film, in order to protect the finish in transit to the customer or to provide vehicles temporarily with printed advertising. Furthermore, temporary masking films are in widespread use in finishing (refinishing) in order to mask off areas around repair sites.

In connection with the application of semiconductor devices (dies (dices)) on wafers the use is likewise very common nowadays of adhesive films (referred to, for example, as grinding films or blue tapes) for temporary covering in order to be able to simplify handling for the backside processing or for the separation (singularization by cutting) and, furthermore, more particularly to protect the wafer's frontside on which the actual electronic components are located.

The current trend in the semiconductor fabrication sector is moving in a direction whose aim is to carry out very substantial thinning of the silicon wafer, and hence the carrier of the actual electronic components and circuits, following its production. It is nowadays possible to achieve thicknesses of less than 20 nm. Despite the fact that they are far-reaching, the diverse advantages which accompany such a procedure will not be set out in any more detail here. As an example, however, it may be mentioned that in the case of a wafer of low thickness—and hence also of low-thickness microchips (dies) separated out from the wafer—it is possible effectively to reduce the unwanted crosstalk between the electronic components within the microchip, and also the substrate noise, for example, with the aid of backside metallization. One of the bases for this effect is that decreasing thickness of the silicon layer is also accompanied by a decrease in the intrinsic resistance of the silicon layer. Moreover, a thin wafer possesses a higher thermal conductivity than a thick wafer, which is a desideratum for its subsequent use.

The low thickness, however, not only produces advantages, but instead also gives rise to difficulties, particularly in the context of the further processing of the wafers. A highly thinned wafer becomes increasingly labile and/or bows as a result of stress in the functional coating. Furthermore, its heat capacity is very low. This gives rise to great difficulties and challenges for the downstream processing steps. This relates more particularly to the backside metallization, for which temperatures of approximately 350° C. must be employed and with which, additionally, vacuum compatibility of the wafer to be coated must be ensured. The highly reduced mass and hence the likewise highly reduced heat capacity of the wafer mean that the electrical circuits are burdened to a considerably greater extent by the high metallization temperatures.

Furthermore, the handling of very highly thinned wafers in the typical highly automated operations presents a challenge from the standpoints of mechanical loading and of capacity for further processing in existing handling apparatus.

The procedure when producing thin wafers and/or thin semiconductor components commonly differs from user to user. Generally speaking, however, the process is as follows: In the production of electronic components and circuits (diodes, transistors, ICs, sensors, etc.) a variety of technologies are used to apply components such as, for example, patterns, layers, etc. to wafers (slices of silicon, GaAs or other semiconductor materials and substrates). Presently these wafers, when the manufacturing steps necessary for these purposes have been concluded, are provided on the frontside (active side, i.e., the side on which the applied components are located) with a protective film or some other protective layer (such as, for example, a glass plate contacted by means of wax). The function of this film or layer is to protect the wafer's frontside and hence the applied electrical and mechanical structures during the subsequent thinning of the wafer (by grinding, lapping, abrading, etching, etc. of the backside).

After the film or layer has been applied, the wafer is thinned on the backward side. This reduces the original thickness of the wafer. The residual thickness remaining is determined sustainedly by the mechanical loads to be expected in the course of the subsequent operating steps, which must be withstood without significant increase in the fracture risk or in the risk of any other mechanical damage. For the purpose of improving the fracture properties of the wafer, the thinning may be followed by mechanical and/or chemical treatment of the wafer's backside. Following cleaning steps, where appropriate, the protective film or the carrier layer is stripped or removed from the wafer's frontside. At that point, where appropriate, further manufacturing steps and/or measures for improving the mechanical properties and/or investigations may follow. At this point the backside of the thinned wafer is often patterned and/or coated with a metallic layer and/or layers of a different kind. This coating is accomplished usually by means of sputtering, similar vacuum deposition techniques and/or lithographic techniques, and often entails a thermal load and/or thermal assistance. Following the backside operations (backside coating and/or backside structuring), the film protecting the frontside, or the applied layer assembly, is removed. Following that, the wafer is often placed, with the backside downward (active frontside upward), on a sawing film (expansion film or frame). Finally the wafer is sawn (singularization of the wafer into separate components) by means of rotary separating disks or other mechanical sawing devices. Laser separation methods are now occasionally employed in this operation. Occasionally this operation also entails breaking of the wafers, and, occasionally, supporting processes of scribing are employed, or the wafer is singularized by means of etching processes. With the conventional processes it is very difficult to treat and/or transport thin wafers without an increased risk of fracture or other damage. One of the circumstances giving rise to these difficulties is that the wafer, after thinning, must be exposed to high mechanical loads in relation to its low thickness.

The following forms of loading occur inter alia
a) during the removal or detachment (debonding) of the protective film or protective layer which protects the wafer's frontside during thinning;
b) during the placement of the wafer on the sawing film;
c) during transport between the thinning and the singularization of the wafer (separation into parts of the wafer, in other words into dies or microchips) and all of the manufacturing steps that may possibly be interposed. More particularly, however, during the treatment or coating of the backside.

Alternatively to the processes highlighted, even today there are processes being employed and/developed in which the frontside (the patterned side) of the wafer, even before the thinning operation by means of grinding of scribe structures and/or scribing and/or chemical etching and/or plasma etching of patterns (this concept thus includes trenches as well), is structured in such a way that these structures are exposed by means of mechanical and/or chemical processes during the subsequent thinning operation with the consequence that the wafer is singularized (dicing before grinding). In this case, it is very often a disadvantage that the now singularized parts of the wafer (dies) can no longer be economically handled during the subsequent operating steps. The reason for this lies in the fact that in this case the multiplicity of pre-singularized components must be fixed in such a way that they do not become detached and/or alter their position during the manufacturing steps that must be traversed.

State of the art for the fixing of the wafer for thinning are tapes known as grinding tapes, which are obtainable, for example, from the company Nitto. For this application, pressure-sensitive adhesives (PSAs) are used which are composed of a more or less pressure-sensitively adhesive base polymer of poly(meth)acrylates, to which oligomers and/or monomers having polymerizable double bonds, and photoinitiators that are active under UV radiation, are admixed. The adhesion of the adhesive tape to the wafer is reduced in this case by means of UV radiation, thereby allowing the adhesive tape to be removed again from the wafer.

EP 0 194 706 A1 describes a pressure-sensitively adhesive compound which is composed of an elastic, polyisocyanate-crosslinked poly(meth)acrylate to which polyunsaturated acrylate monomers and/or oligomers, photoinitiators, and resinous tackifiers and/or silica gel are admixed.

EP 0 298 448 A1 cites polyisocyanate-crosslinked polyacrylate PSAs which are mixed with polyacrylated cyanurates or isocyanurates and photoinitiators.

EP 0 622 833 A1 claims a pressure-sensitive adhesive which is prepared from an OH-containing, diisocyanate-crosslinked polyacrylate and also from a urethane oligomer with a molar weight of approximately 6000 which has at least two acrylic double bonds, and photoinitiators.

A similarly prepared pressure-sensitive adhesive is described in DE 36 39 266 A1. JP 06 049 420 A claims a pressure-sensitive adhesive which is mixed from a base polymer, polyfunctional urethanes having molar weights of 15000 to 50000 g/mol, plasticizers, and photoinitiators.

Deviating from the processes described in general above, EP 0 588 180 A1 cites an uncompounded pressure-sensitive adhesive which comprises a copolymerized photoinitiator and which loses bond strength on UV irradiation. One of the major constituents of this acrylic copolymer are acrylate ester units with alkyl groups</=C14.

EP 0 252 739 A2 and DE 195 20 238 C2 as well disclose adhesive tapes for holding wafers.

With the presently typical solutions for grinding tapes it is very difficult and in some instances impossible to thin down wafers to very low thicknesses, since the pressure-sensitive adhesives used do not develop sufficient contact to the structured surface of the wafer. The thinned wafers or the pre-singularized parts of the already thinned wafer (dies) can also not be coated economically on the wafer's backside, owing to the lack of temperature resistance.

Where this is done at present, there are large manufacturing losses due to wafer fracture and/or other damage, and/or considerable manual measures are necessary in order to avoid such events. In this context it is necessary at the present time for the wafers and/or the singularized wafer pieces to be treated, usually in a very costly and inconvenient way, and/or with very great care, by human hand and/or by means of costly and complex apparatus. The reason for the difficulty in this case lies more particularly in the extremely thin wafer material and/or in the multiplicity of the wafer pieces which may have already been singularized.

To date there has also been no satisfactory solution which has been realized on the industrial scale that makes it possible to provide a highly thinned wafer with backside metallization, since all forms of existing carrier films fail on account of the high metallization temperature required.

From the present-day standpoint, surfaces for coating which are employed include, primarily, wafer surfaces which have been provided with a protective layer of silicon nitride and/or silicon oxide or polyimide. In principle, though, other materials are also not excluded. Moreover, the surfaces are generally structured by electrical circuits or, additionally, by a dicing process for preparing the wafers for separation into individual dies.

Known from the prior art are wafer processing processes wherein, in particular, the wafer's frontside is temporarily covered for protection and/or for greater ease of handling. DE 100 29 035 C1, for instance, discloses a wafer processing process in which a so-called support wafer is applied to the wafer that is to be processed. The two wafers are connected by means of a connecting layer which is introduced partly into holes in the support wafer and so lies on the parts of the wafer to be processed that are exposed by the holes. After processing steps have been carried out on the backside of the wafer to be processed, the support wafer is separated off again by removal of the connecting layer.

U.S. Pat. No. 5,981,391 A discloses a process for fabricating a semiconductor device that includes the protecting of the frontside of a wafer by an adhesive medium and also the removal of said adhesive medium after the backside of the wafer has been processed, and the heating of the wafer, following the removal of the adhesive medium, to a temperature which is higher than the thermal decomposition temperature of the adhesive made available by the adhesive medium.

WO 99/08322 A1 discloses a coated wafer where the coating always comprises at least titanium.

WO 99/48137 A1 likewise discloses a wafer provided with a layer intended to protect the frontside of the wafer in the course of subsequent processing steps. Subject matter of this kind is also disclosed in DE 198 11 115 A1; in both documents the layer remains on the wafer at least until the wafer has been singularized into dies.

U.S. Pat. No. 6,263,566 B1 likewise discloses a wafer with a coating of which selected regions can be removed again after processing steps have taken place.

The company brochure “Wafer Support System” from 3M (St. Paul, Minn., USA, No. 4834 (HB) 60 5002 0049-2) likewise discloses a method of fixing a wafer for thinning, in which the wafer is fixed on a very planar glass plate by means of a light-to-heat conversion (LTHC) layer and a UV-curable liquid adhesive. By exposing the LTHC to a laser it is possible to detach the glass plate, and then the cured liquid adhesive can be stripped from the wafer's surface.

WO 2004/051708 A2 discloses a process for the processing of a wafer that carries components on one side (frontside), comprising the following steps: Applying a layer system to the frontside of the wafer, the layer system comprising at least one separation layer, that contacts the frontside of the wafer, and one carrier layer; thinning the backside of the wafer, so that the layer system protects or carries (holds) the wafer or parts of the wafer during thinning. The separation layer is a plasma-polymeric layer which adheres to the wafer and which adheres to the carrier layer more firmly than to the wafer. The processes of PECVD or plasma polymerization, for the separation layer, and spin coating, for the application of the carrier layer, are employed, these processes being commonplace in the semiconductor industry. As the carrier layer the proposal is for polyamide or polyamide precursor or liquid silicone, which, following application, is cured and can be removed again as a layer. A disadvantage is the poor layer thickness which can be achieved by spin coating, with the consequence that the operation must be repeated a number of times in order to attain the layer thickness necessary for mechanical stability during stripping of the layer assembly. The planarity of a multiply applied layer of this kind, furthermore, would not be sufficient for a reference surface for thinning. The likewise proposed application of a support film would necessitate an additional operation.

A further challenge not yet satisfactorily resolved in the state of the art is the fixing of bumped wafers. Current grinding tapes, in particular, are unsuited to the purpose, since the projecting bumps (solder balls) mean that the surface is not adequately wetted by the pressure-sensitive adhesives that are used. In addition, the technology used for switching off the tapes' adhesion properties for the separation of the wafer (curing of the adhesive by means of operations initiated thermally or UV radiation) are less suitable for bumped wafers, since in that case the pressure-sensitive adhesive is also cured in the undercuts on the bumps and, consequently, release does not occur or else the bumps are damaged.

All of the coatings disclosed in the prior art are not yet optimal and, for example, can be separated from the wafer again only partially or in a way involving a high degree of cost and complexity. Furthermore, the application of the layers is frequently awkward, inevitably taking place in two or more operations, and the layer material is not optimally matched to its functions.

It is an object of the invention, therefore, to provide a process which accomplishes the secure fixing of a layer material to highly structured surfaces, more particularly those of bumped wafers, where preferably the layer material can be released again from the surface. With further preference it is intended that a high level of thermal stability both in mechanical and in chemical respects should be achieved, that allows, for example, the backside coating of wafers.

This object is achieved by means of a process as recorded in the main claim. The dependent claims provide advantageous developments of the process.

The invention accordingly provides a process for the temporary fixing of a polymeric layer material on rough surfaces, which encompasses at least one viscoelastic layer with the following properties:
the attainment of a shear stress of at least 1000 Pa in the shear stress ramp test at a temperature of 20° C. with a shear stress ramp of 100 Pa/min, without the viscoelastic material beginning to flow,
a complex viscosity eta* of less than 50 000 Pas in the oscillatory shear experiment (DMA) at the application temperature and at a frequency of 0.01 s⁻¹,
the capacity to increase the cohesion and thus lower the fluidity by crosslinking of the layer,
the at least partial elastomeric character after crosslinking for subsequent separation from the surface without residue after crosslinking.

The layer material is first placed on the rough surface.

Energy is introduced to lower the viscosity of the at least one viscoelastic layer in the layer assembly, so that there is flow onto the rough surface.

The layer is crosslinked, to give a layer having at least partial elastomeric character that at least partly wets the rough surface.

By a rough surface (referred to alternatively below as a structured surface) is meant a surface having a depth of roughness Rₘₐₓ to DIN 4768 of at least 10 μm.

The shear stress ramp test is used to determine any yield point or to demonstrate that the material is not fluid. It involves subjecting a sample to a shear stress which increases continuously with time. The shear stress at which the sample begins to flow is referred to as the yield point (or yield stress). The test is described at length in Rudiger Brummer's “Rheology Essentials of Cosmetic and Food Emulsions”, Springer, 2005, pages 65 to 67.

The attainment of a shear stress of at least 1000 Pa in the shear stress ramp test at a temperature of 20° C. without the viscoelastic material beginning to flow characterizes low or no cold flow of the viscoelastic layer. By cold flow here is meant the flow of the viscoelastic layer under the influence of gravity or of another low force acting permanently during storage, such as the winding pressure in a roll of the layer material of the invention, for example. The cold flow is preferably so low that the layer material can be stored for at least six months at room temperature in a plurality of plies (as sheet product or on a roll) without the viscoelastic layers of the respective plies coming into contact with one another and the plies thus sticking to one another.

The attainment of a shear stress of at least 1000 Pa in the shear stress ramp test at a temperature of 20° C. without the viscoelastic material beginning to flow is achieved through thixotropic rheological characteristics or through a pronounced (apparent) yield point of the viscoelastic material. These rheological properties are defined at length in Pahl et al., “Praktische Rheologie der Kunststoffe und Elastomere”, VDI-Verlag, 1995, pages 53 to 55 and pages 385 to 389. Alternatively this property is achieved by the at least one layer being present, during storage, at least partly in the form of a solid, such as thermoplastic or elastomer, for example, at room temperature.

In one preferred embodiment of the invention, thixotropic flow behavior or a yield point is achieved through the addition of fillers. Preference is given in that case to fillers which on account of particle interactions are capable of forming a filler network. Suitable here, for example, are fumed silicas, phyllosilicates, nanotubes or carbon blacks.

Furthermore, the aforementioned flow behavior is achieved preferably by the formation of a gel network within the polymer.

In a technical sense, gels are readily deformable disperse systems of relative dimensional stability that are composed of at least two components, consisting generally of a colloidally disintegrated substance comprising long-chain molecular moieties (for example, gelatins, polysaccharides, celluloses and their derivatives, block copolymers) as scaffold-formers and of a liquid dispersion medium (in this case, for example, a fluid polymer). The colloidally disintegrated substance is often referred to as a thickener or gelling agent. It forms a three-dimensional network within the dispersion medium, where individual particles, present colloidally, may be linked more or less firmly to one another via interactions. The dispersion medium which surrounds the network is distinguished by its affinity for the gelling agent: in other words, a predominantly polar gelling agent preferentially gels a polar dispersion medium, whereas a predominantly nonpolar gelling agent preferentially gels nonpolar dispersion media.

Strong electrostatic interactions, which are realized, for example, in hydrogen bonds between gelling agent and dispersion medium, but also between individual dispersion medium molecules, can lead to strong crosslinking of the dispersion medium as well. Hydrogels may, for example, be composed almost 100% of water (besides, for example, about 0.2 to 1.0% of a gelling agent) and still have a solid consistency. In that case the water fraction is present in icelike structural elements.

The complex viscosity eta* of less than 50 000 Pas in an oscillatory shear experiment at an application temperature and at a frequency of 0.01 s⁻¹ denotes a low viscosity during application to the structured surface. PSAs of typical grinding tapes here typically give values of more than 100 000 Pas. The oscillatory shear experiment is defined in detail in Pahl et al., “Praktische Rheologie der Kunststoffe und Elastomere”, VDI-Verlag, 1995, pages 119 to 150. The values reported here apply when using a plate-plate configuration with a plate diameter of 25 mm.

The low viscosity during application is achieved by raising the temperature and/or by applying shearing forces and/or extensional forces. This increase in temperature brings about softening of the layer material, which, as a result, becomes more fluid. Shearing forces and/or extensional forces likewise lead to a reduction in viscosity in structurally viscous materials, and hence to the improved flow into the structured surface. This property can be achieved in principle with all polymers that are known to the skilled worker and that exhibit structurally viscous flow behavior and/or are meltable. Additionally, in the case of corresponding materials, shearing forces and/or extensional forces lead to the dissolution of the filler network or gel and hence to a reduction in the viscosity. Flow onto the structured surface is supported preferably by pressing.

The increase in temperature in this case can be achieved by any method known to the skilled worker. Such methods comprise thermal conduction through heating plates, convection through heated gases or liquids, use of electromagnetic waves (for example, infrared, microwaves, alternating magnetic or electrical fields), and chemical or physical transformations; this enumeration is not intended to exclude methods not specified.

Shearing forces and/or extensional forces are applied simply by the pressing of the layer material onto the structured surface. High pressure increases these forces. A structurally viscous rheological behavior on the part of the layer material leads to a reduction in the viscosity. Structurally viscous behavior is likewise defined in Pahl (see above). The shearing forces and/or extensional forces may be reinforced further by the application of displacement forces on the layer material. Pressing forces or displacement forces may also with advantage be applied oscillatingly, thereby allowing the mechanical distances during the application to be minimized or, in the case of a given mechanical distance, the duration of exposure to be increased.

To increase the cohesion, the viscoelastic materials that are used for the inventive layer materials, following flow onto the structured surface, are crosslinked, the aim being for high degrees of crosslinking in order to achieve a high level of temperature stability. According to one preferred embodiment of the invention the at least one viscoelastic material has a degree of crosslinking which corresponds at least to a gel value of 50%, more particularly of at least 75%. The gel value here is defined as the ratio of component not soluble in a suitable solvent to soluble component.

In one preferred procedure the PSAs are crosslinked using UV rays or electron beams. A detailed description of the state of the art and the most important process parameters are found in “Chemistry and Technology of UV and EB formulation for Coatings, Inks and Paints”, Vol. 1, 1991, SITA, London. It is also possible to employ other processes which enable high-energy irradiation.

In order to reduce the radiation dose necessary it is possible to admix crosslinkers and/or crosslinking promoters to the viscoelastic material, more particularly crosslinkers and/or promoters which are excitable by means of UV rays, by means of electron beams or thermally. Suitable crosslinkers for radiation crosslinking are difunctional or polyfunctional acrylates or methacrylates. In a further preferred embodiment the PSAs are crosslinked using thermally activable crosslinkers. For that purpose it is preferred to admix peroxides, metal chelates, difunctional or polyfunctional epoxides, difunctional or polyfunctional hydroxides, and difunctional or polyfunctional isocyanates.

The rubber-elastic state is defined in Ferry's “Viscoelastic Properties of Polymers” (3rd edition, John Wiley & Sons, New York, 1980), pages 233 to 240. In accordance with the invention, therefore, the rubber-elastic state is not achieved ideally even when the material continues to have a low fluidity. At least, however, the tan delta in the oscillatory shear experiment at a separating temperature and at a frequency of 100 s⁻¹ is below 1. The high elasticity of the layer is achieved, for example, by virtue of the glass transition temperature of the viscoelastic material used being—after crosslinking—below the temperature at which the layer material is separated from the structured surface. The glass transition temperature is preferably below room temperature. As a result of the high elasticity, easy and damage-free removal from the surface is made possible, more particularly in the case of patterns with undercuts, such as bumped wafers, for example. Here, the cohesion, increased by crosslinking, contributes to the avoidance of residues.

In one preferred version of the invention the viscoelastic layer possesses a thickness of more than 100 μm, more preferably more than 200 μm. This ensures the complete enveloping even of relatively large bumps.

In one advantageous version of the invention the at least one viscoelastic layer is resistant for at least one hour to a temperature of more than 200° C., preferably more than 300° C., in order thus, for example, to allow the backside of a wafer to be treated. The temperature resistance is determined by means of thermogravimetric analysis. In this case the sample is heated at a rate of 10° C./min under an inert gas atmosphere, and is weighed at the same time. The weight loss is plotted against the temperature. Weight loss below 150° C. is generally ascribed to the outgassing of water, residual solvents or residual monomers, while weight loss above 150° C. is generally ascribed to thermal degradation of the sample.

Preference is therefore given to using polymers of high temperature stability, such as silicones, acrylates or synthetic rubbers, for example, without wishing to impose any restriction on the selection by the giving of this list. In one preferred version the viscoelastic layer is pressure-sensitively adhesive, since this facilitates application to the rough surface.

As possible silicone compositions it is possible to make use, for example, of DC 280, DC 282, Q2-7735, DC 7358, Q2-7406 from Dow Corning, PSA 750, PSA 518, PSA 6574 from GE Bayer Silicones, KRT 001, KRT 002, KRT 003 from ShinEtsu, and silicone rubbers from the Elastosil series and Powersil series and also PSA 45559 from Wacker Silicones, without wishing to impose any restriction on the selection as a result of these names.

With advantage in accordance with the invention it is possible as a viscoelastic layer to use PSAs based on acrylic acid and/or methacrylic acid and/or based on esters of the aforementioned compounds. Particularly suitable as an adhesive component are acrylate PSAs which are obtainable, for instance, by free-radical addition polymerization and which are based at least partly on at least one acrylic monomer of the general formula (1)

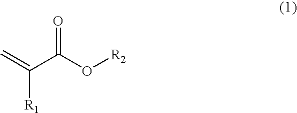

where R₁ is H or a CH₃ radical and R₂ is H or is chosen from the group of the saturated, unbranched or branched, substituted or unsubstituted C₁ to C₃₀ alkyl radicals. The at least one acrylic monomer ought to have a mass fraction of at least 50% in the PSA.

According to one particularly advantageous version polymers are employable as adhesive component which

(a1) are based at least partly on at least one acrylic monomer of the general formula CH₂═C(R₁)(COOR₂), where R₁ is H or a CH₃ radical and R₂ is selected from the group of saturated, unbranched or branched, substituted or unsubstituted C₂ to C₂₀ alkyl radicals, and
(a2) are based at least partly on a comonomer which is polymerizable with the at least one acrylic monomer and which may be selected in particular from vinyl compounds with functional groups, maleic anhydride, styrene, styrene compounds, vinyl acetate, acrylamides, and double-bond-functionalized photoinitiators.

Preferably the at least one acrylic monomer (a1) has a mass fraction of 65% to 100% by weight and the at least one monomer (a2) has a mass fraction of 0 to 35% by weight in the adhesive component.

Very preferentially use is made of acrylic or methacrylic monomers of the general formula (I) which comprise acrylic and methacrylic esters where the group R₂ is selected from the group of saturated, unbranched or branched, substituted or unsubstituted C₄ to C₁₄ alkyl radicals, especially C₄ to C₉ alkyl radicals. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, examples being isobutyl acrylate, 2-ethylhexyl acrylate, 2-ethylhexyl methacrylate, isooctyl acrylate, and isooctyl methacrylate.

Further classes of compound to be used are monofunctional acrylates and/or methacrylates of the general formula (I) where the radical R₂ is selected from the group of bridged or unbridged cycloalkyl radicals having at least 6 C atoms. The cycloalkyl radicals may also be substituted, by C₁ to C₆ alkyl groups, halogen atoms or cyano groups, for example. Specific examples are cyclohexyl methacrylate, isobornyl acrylate, isobornyl methacrylate, and 3,5-dimethyladamantyl acrylate.

In one preferred procedure acrylic monomers and/or comonomers are used which have one or more substituents, especially polar substituents, examples being carboxyl, sulfonic acid, phosphonic acid, hydroxyl, lactam, lactone, N-substituted amide, N-substituted amine, carbamate, epoxy, thiol, alkoxy, cyano, halide, and ether groups.

Suitable with very great advantage in the sense of acrylic component (a1) are monomers selected from the following group:

substituted or unsubstituted compounds, comprising methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, isobutyl acrylate, 2-ethylhexyl acrylate, 2-ethylhexyl methacrylate, isooctyl acrylate, isooctyl methacrylate, cyclohexyl methacrylate, isobornyl acrylate, isobornyl methacrylate, and 3,5-dimethyladamantyl acrylate.

Likewise suitable are moderately basic comonomers (a2), such as singly or doubly N-alkyl-substituted amides, especially acrylamides. Specific examples here are N,N-dimethylacrylamide, N,N-dimethylmethacrylamide, N-tert-butylacrylamide, N-vinylpyrrolidone, N-vinyllactam, dimethylaminoethyl acrylate, dimethylaminoethyl methacrylate, diethylaminoethyl acrylate, diethylaminoethyl methacrylate, N-methylolacrylamide, N-methylolmethacrylamide, N-(butoxymethyl)methacrylamide, N-(ethoxymethyl)acrylamide, and N-isopropylacrylamide, this enumeration not be exhaustive.

Further preferred examples of comonomers (a2), owing to the functional groups utilizable for crosslinking, are hydroxyethyl acrylate, hydroxyethyl methacrylate, hydroxypropyl acrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl acrylate, 2-butoxyethyl methacrylate, cyanoethyl acrylate, cyanoethyl methacrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid, this enumeration not being exhaustive.

In a further very preferred procedure comonomers (a2) used are vinyl compounds, especially vinyl esters, vinyl ethers, vinyl halides, vinylidene halides, vinyl compounds with aromatic rings and heterocycles in α position. Here too mention may be made, nonexclusively, of certain examples, such as vinyl acetate, vinylformamide, vinylpyridine, ethyl vinyl ether, vinyl chloride, vinylidene chloride, styrene, and acrylonitrile.

With particular advantage the at least one comonomer (a2) can be a photoinitiator having a copolymerizable double bond, selected in particular from the group containing Norrish I or Norrish II photoinitiators, benzoin acrylates or acrylated benzophenones.

In one further preferred procedure the comonomers (a2) described are admixed with monomers which possess a high static glass transition temperature. Suitable components include aromatic vinyl compounds, such as styrene, for example, with the aromatic nuclei being composed preferably of C₄ to C₁₈ units and being able also to contain heteroatoms. Particularly preferred examples are 4-vinylpyridine, N-vinyl-phthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butyl-phenyl methacrylate, 4-biphenylyl acrylate and methacrylate, 2-naphthyl acrylate and methacrylate and mixtures of those monomers, this enumeration not being exhaustive.

Very particular preference is given to compositions predominantly consisting of comonomers having linear side chains, such as methyl acrylate or butyl acrylate, for example. Particularly advantageous for a high temperature stability, furthermore, is covalent crosslinking of the acrylate PSAs.

As temperature-stable synthetic rubbers it is advantageous to use styrene block copolymers with a hydrogenated middle block, such asSEBS, SEP, SEPS or SEEPS, available, for example, from the company Kraton (Kraton G) or Kuraray (Septon). Particular preference is given here to functionalized types such as the Kraton FG series, Asahi Tuftec™ M 1913 or Tuftec™ 1943, or Septon HG252 (SEEPS-OH). Further preferred block copolymers are, for example, obtainable under the name Epofriend™ A 1005, A 1010 or A 1020 from Daicel. By adding suitable crosslinking agents (for example, polyfunctional isocyanates, amines, epoxides, alcohols, phenols, guanidines, mercaptans, carboxylic acids and/or acid anhydrides) it is possible for these to be crosslinked and hence thermally stabilized. Also a combination of acid-modified or acid anhydride-modified vinylaromatic block copolymer (for example Kraton FG series) and an epoxidized vinylaromatic block copolymer (for example, Daicel Epofriend series) can be utilized advantageously.

In one preferred version the layer material includes at least one further layer which covers the viscoelastic layer on at least one side and serves as a release liner which is removed at least on one side prior to application to the structured surface. This version is advantageous more particularly in the case of pressure-sensitively adhesive viscoelastic layers.

In a further preferred version of the layer material the layer material includes a layer which serves as a permanent carrier of the viscoelastic layer. This serves for the further stabilization of the viscoelastic layer during storage, application, and detachment. Possible here in principle are all of the carrier materials known to the skilled worker, of the kind specified, for example, in the “Handbook of Pressure Sensitive Adhesive Technology” by Donatas Satas (van Nostrand, New York 1989). Preference is given to thin sheets, more particularly metal foils or high-temperature-resistant polymer films, such as, for example, polyimide, polyamideimide, polysulfone, polyethersulfone, polyetherketone, polyetheretherketone, polyetherimide, polyphenylene sulfide, fluorinated polymers (PTFE etc.). To enhance the adhesion of the viscoelastic layer it is possible for this carrier material to have been chemically or physically pretreated, in which case all of the methods known to the skilled worker may be employed.

In a further preferred version of the layer material the layer material includes a release mechanism in relation to the structured surface. In one advantageous version this separation mechanism is integrated into the viscoelastic layer. For that purpose this layer comprises, for example, an incompatible polymer which, in response to a stimulus such as, for example, an increase in temperature, migrates to the interface between layer material and structured surface. A mechanism of this kind is described in U.S. Pat. No. 5,412,035 A1 without any intention that the invention should be restricted thereto.

In a further advantageous version the separation mechanism is actualized in a further ply of the layer assembly, which then forms a boundary layer to the structured surface. In this case it is possible for all of the release agents known to the skilled worker to be employed, such as waxes, fats, oils, fluorinated polymers or silicones, for example. In one particularly preferred version this layer is thinner than 1 μm, more particularly thinner than 100 nm.

Acting as a separation layer, furthermore, is preferably a layer which is at least rich in particles but which can also be composed almost exclusively of particles, the particles ideally not entering into any interaction with the substrate surface but having an extremely high affinity for the viscoelastic layer. In order to facilitate flow of the viscoelastic layer into the structures of the substrate surface, it is particularly advantageous if these particles in at least one plane have dimensions below 100 nm. Examples of suitable particles include precipitated or pyrogenic silicates, which may also have been surface-modified, polymer beads or glass beads, phyllosilicates of natural or synthetic origin, nanoparticles of silica (for example Clariant Highlink OG) or metal oxides (for example, Byk-Chemie Nanobyk series), without wishing to impose any restriction on the selection as a result of this list.

The latter construction of the separation layer can be employed advantageously, beyond this invention, in many other applications as well. The method of separation through the use of nanoparticles as a separation layer can be used independently of the process of the invention that is described here.

It may further be advantageous to select the materials of the layer material such that the material exhibits very few or no reactions in vacuum—through outgassing, for example. For coating operations it is advantageous if the layer material used has a high thermal conductivity and therefore permits the deliberate heating of the substrate, the wafer for example, or specifically removes the heat. This property can be obtained, for example, through the addition of suitable fillers. In addition it is frequently advantageous to select the layer material in such a way that it is adapted to the substrate material in terms of its attitude to temperature fluctuations: for example, by choosing material and layer material such that they possess very similar thermal expansion coefficients (for example, ratio of thermal expansion coefficient of layer material:thermal expansion coefficient of wafer is situated preferably in the range from 0.9 to 1.1).

The layer material of the invention solves such problems associated with the production of very thin wafers and their backside treatment. With the use of the material, therefore, a process for processing a wafer which carries components on one side (frontside) is also claimed. This process is distinguished by the following steps:
applying a layer assembly of the invention to the frontside
lowering the viscosity of the at least one viscoelastic layer in the layer assembly by introducing energy, so that there is flow onto the wafer's frontside and hence an at least partial physical bond thereto takes place
crosslinking of the at least one viscoelastic layer
thinning and/or coating and/or treatment of the wafer's backside.

In one preferred version of the process, the introduction of energy and the flow of the layer material onto the wafer surface take place in a bonding press of the kind available, for example, from the company EVG. As a result of this it is possible to achieve excellent plane-parallelism of the wafer backside with the side of the layer material facing away from the wafer surface.

With particular preference this step of the process takes place in a vacuum. This prevents gas inclusions between layer material and wafer frontside.

In one further preferred version of the process, the wafer, which may also be a wafer which even before the thinning operation has been structured on its frontside (the structured side) by means of grinding and/or scribing and/or chemical etching and/or plasma etching of trenches and/or other structures in such a way that, during a subsequent thinning operation, these structures are exposed by means of mechanical and/or chemical methods (etching, for example) and in that case, consequently, there is singularization of the wafer, is coated prior to thinning (ablation of material on the backside) on the frontside with a separation layer. This separation layer is in this case applied preferably by means of CVD methods. This separation layer may be, for example, a plasma-polymeric coating of the kind developed at the Fraunhofer Institute for Manufacturing Technology and Applied Materials Research at Bremen (see WO 2004/051708 A2). It is possible for the separation layer to be obtained in its full thickness by the CVD operation and/or by another vacuum operation and/or to be supported and/or obtained by application (beforehand where appropriate) of a suitable material. In this case it is preferred to set separation layer thickness of 1 to 1000 nm, preferably 50 to 200 nm. The layer thickness may, however, also be smaller or greater.

A constituent of the water—and this is the way in which the term “wafer” is to be understood in the context of this text—can also be a passivation coat on the wafer's frontside, preferably when the wafer comprises electronic components. Such a passivation coat (where present) is located directly in contact with the layer of the wafer that carries the electronic components.

The thinning in the process of the invention may take place, for example, chemically (etching) and/or mechanically.

In one preferred version of the process the layer material is detached from the wafer again after processing.

In this case the reduction in the adhesion of the layer material is achieved as a result of irradiation with electromagnetic waves, thermal exposure, chemical exposure and/or mechanical exposure. This thermal exposure may consist of heating or cooling or both procedures.

Preference is given in this context to a process of the invention in which the layer material is mechanically delaminated from the carrier layer or from the wafer or from the parts of the wafer.

To detach the wafer it is preferred to apply a (further) film (for example, blue tape, dicing tape) to the backside of the wafer and then to remove the inventive layer material applied to the frontside. In the course of the detachment of this layer it can be advantageous to employ mechanical devices which facilitate removal. Detachment is facilitated more particularly, however, by a separation layer present within the layer material or located between wafer surface and layer material.

The invention permits the realization of substantial technological advantages in the manufacture and handling of wafers during the production of electrical components, ICs, sensors, etc. With the layer material of the invention and with the process of the invention, fabrication is simplified and made more cost-effective. Furthermore, lower wafer thicknesses can be realized more easily, more economically, and more reliably.

Beyond the carrier solutions that are presently employed (carriers in the form of films or other layer systems consisting, for example, of glass in conjunction with wax) there are advantages more particularly associated with methods for the backside coating of thin wafers, particularly when these coatings take place under vacuum and/or under a thermal load. In that case the handling of the thin wafers or of the pre-singularized components is simplified by the wafer and/or the singularized wafer parts being fixed and/or mechanically supported by the applied layer material. If the wafer surface possesses sufficient topographical conditions, the singularized parts of the wafer are also fixed by this means.

This effect can also be achieved and/or supported if, for the purpose of singularization, the wafer surface has been structured on its frontside (dicing before grinding). The reason for this is that, consequently, the layer material of the invention is then introduced into the structures that come about as a result of said structuring, and mechanical anchoring of the subsequently singularized wafer parts is achieved.

A further advantage is that a (frontside) applied layer material of the invention is able to protect the topography of the wafer surface very well and probably better than the films that are currently in use. The unwanted pressing-through of elevations on the wafer surface during mechanical thinning procedures can therefore be reduced or even ruled out.

A further advantage is that the layer material can be applied from a sheet or from a roll in a single operation without instances of contamination as a result, for example, of overswelling liquid materials and without problematic fluctuations in thickness in the case of coating operations involving fluids.

The invention is described below by means of experiments and also examples, without wishing any unnecessary restriction to follow from the choice of the samples investigated.

The test methods employed were as follows:
The shear stress ramp test (test A)

This test is carried out under torsion in a shear stress-controlled rheometer of type DSR from Rheometrics, with a shear stress ramp of 100 Pa/min at room temperature, using a plate-plate geometry with a plate diameter of 25 mm. Details are described in Brummer (see above).
Oscillatory shear experiment: Dynamic mechanical analysis (DMA, test B)

The test serves to investigate rheological properties and is described in detail in Pahl (see above). The test is run under torsional load in a shear rate-controlled rheometer from Ares, using a plate-plate geometry with a plate diameter of 25 mm. For the results, temperature and frequency are reported in each case.
Thermogravimetric analysis (TGA, test C)

The test serves to determine the temperature stability. The sample is heated at a rate of 10° C./min under an inert gas atmosphere and is weighed at the same time. The loss in weight is plotted against the temperature. Weight loss below 150° C. is generally ascribed to the outgassing of water, residual solvents or residual monomers; weight loss above 150° C. is generally ascribed to thermal degradation of the sample.
Determination of the gel value (test D)

The carefully dried, solvent-free samples of adhesive are welded into a pouch made of polyethylene nonwoven (Tyvek web). The difference in the sample weights before and after extraction with toluene is used to determine the gel value, in other words the toluene-insoluble weight fraction of the polymer.

### EXAMPLE 1

The silicone compound PSA 518 from GE Bayer Silicones was mixed with 5% by weight of Aerosil R202 (Degussa) and 5% by weight of benzoyl peroxide (BPO). This composition was coated out with a coat weight of 300 g/m² onto a 127 μm Kapton 500HN film from DuPont, and dried at a temperature of 60° C., so that the BPO did not at this point disintegrate. The composition was then covered with a fluorosilicone-coated film liner from Loparex.

The adhesive tape produced in this way exhibited excellent storage stability on a roll at room temperature. No running of the composition from the roll was observed over a period of 3 months.

Test A showed a yield point for the composition of 2400 Pa.

Test B showed a complex viscosity eta* at a frequency of 0.01 s⁻¹ and an application temperature of 160° C. of 20 000 Pas.

The adhesive tape was applied to a prestructured wafer surface with bumps. This wafer was already coated with a release layer, approximately 50 nm thick, of AK 50 type silicone oil from Wacker-Chemie. Under a vacuum press, the adhesive tape was pressed with a pressure of 300 kPa. For this operation the press was heated to a temperature of 160° C. and so the material underwent crosslinking.

When the adhesive tape was removed from the wafer, it exhibited sufficient cohesion and so could be removed without residue.

Test C was used to investigate the temperature stability after crosslinking. Incipient degradation was apparent only from a temperature of 310° C.

Test D showed a gel value of 52%.

### EXAMPLE 2

The silicone compound ELASTOSIL® R 830 18/45 from Wacker Silicones was mixed with 1% by weight of curing agent C6 (2,5-bis(t-butylperoxy)-2,5-dimethylhexane, 45% by weight in silicone rubber) and 15% by weight of Aerosil R202 (Degussa). This composition was applied with a coat weight of 200 g/m² to a 127 μm Kapton 500HN film from DuPont in a calendering process, and dried at a temperature of 60° C., so that the crosslinking reaction did not commence. The composition was then covered with a fluorosilicone-coated film liner from Loparex.

The adhesive tape produced in this way exhibited excellent storage stability on a roll at room temperature over a period of 2 months. Coalescence of the individual plies of the roll was not observed.

Test A showed a yield point for the composition of 5300 Pa.

Test B showed a complex viscosity eta* at a frequency of 0.01 s⁻¹ and an application temperature of 170° C. of 100 Pas.

The adhesive tape was applied to a prestructured wafer surface with bumps. This wafer was already coated with a release layer, approximately 50 nm thick, of AK 50 type silicone oil from Wacker-Chemie. Under a vacuum press, the adhesive tape was pressed with a pressure of 300 kPa. For this operation the press was heated to a temperature of 170° C. and so the material underwent crosslinking.

When the adhesive tape was removed from the wafer, it exhibited sufficient cohesion and so could be removed without residue.

Test C was used to investigate the temperature stability after crosslinking. Incipient degradation was apparent only from a temperature of 360° C.

Test D showed a gel value of 98%.

### EXAMPLE 3

A random polyacrylate copolymer having the composition below was prepared by a process known to the skilled worker:

20% by weight methyl acrylate
7% by weight acrylic acid
64% by weight ethylhexyl acrylate
9% by weight hydroxyethyl methacrylate

The weight-average molecular weight M_{w} was 870 000 g/mol.

In a 50% strength solution of the copolymer in acetone, 11% of Aerosil R202 from Degussa and 5% of a blocked isocyanate (type Trixene BI 7950 from Baxenden) were mixed in, based in each case on the solids content.

This composition was applied with a coat weight of 300 g/m² to a 127 μm Kapton 500HN film from DuPont in a coating process with a drying temperature of 80° C., so that the crosslinking reaction did not commence. The composition was then covered with a silicone-coated film liner from Siliconature.

The adhesive tape produced in this way exhibited excellent storage stability on a roll at room temperature over a period of 3 months. Coalescence of the individual plies of the roll was not observed.

Test A showed a yield point for the composition of 4600 Pa.

Test B showed a complex viscosity eta* at a frequency of 0.01 s⁻¹ and an application temperature of 140° C. of 35 000 Pas.

The adhesive tape was applied to a prestructured wafer surface with bumps. This wafer was already coated with a release layer, approximately 50 nm thick, of AK 50 type silicone oil from Wacker-Chemie. Under a vacuum press, the adhesive tape was pressed with a pressure of 300 kPa. For this operation the press was heated to a temperature of 140° C. and so the material underwent crosslinking.

When the adhesive tape was removed from the wafer, it exhibited sufficient cohesion and so could be removed without residue.

Test C was used to investigate the temperature stability after crosslinking. Incipient degradation was apparent only from a temperature of 270° C.

Test D showed a gel value of 74%.

### EXAMPLE 4

A random polyacrylate copolymer having the composition below was prepared by a process known to the skilled worker:

20% by weight methyl acrylate
7% by weight acrylic acid
64% by weight butyl acrylate
9% by weight hydroxyethyl methacrylate

The weight-average molecular weight M_{w} was 790 000 g/mol.

In a 50% strength solution in acetone, 11% of Aerosil R202 from Degussa and 5% of a blocked isocyanate (type Trixene BI 7950 from Baxenden) were mixed in, based in each case on the solids content.

This composition was applied with a coat weight of 300 g/m² to a 127 μm Kapton 500HN film from DuPont in a coating process with a drying temperature of 80° C., so that the crosslinking reaction did not commence. The composition was then covered with a silicone-coated film liner from Siliconature.

The adhesive tape produced in this way exhibited excellent storage stability on a roll at room temperature over a period of 3 months. Coalescence of the individual plies of the roll was not observed.

Test A showed a yield point for the composition of 5100 Pa.

Test B showed a complex viscosity eta* at a frequency of 0.01 s⁻¹ and an application temperature of 140° C. of 26 000 Pas.

The adhesive tape was applied to a prestructured wafer surface with bumps. This wafer was already coated with a release layer, approximately 50 nm thick, of AK 50 type silicone oil from Wacker-Chemie. Under a vacuum press, the adhesive tape was pressed with a pressure of 300 kPa. For this operation the press was heated to a temperature of 140° C. and so the material underwent crosslinking.

When the adhesive tape was removed from the wafer, it exhibited sufficient cohesion and so could be removed without residue.

Test C was used to investigate the temperature stability after crosslinking. Incipient degradation was apparent only from a temperature of 290° C.

Test D showed a gel value of 76%.

It is apparent thereby that through the use of linear radicals R₂ (see above) it is possible to raise the temperature stability.

### EXAMPLE 5

In a 50% strength solution in toluene, 95% of Epofriend A 1010 from Daicel and 2% of Dyhard 100s from Degussa (dicyandiamide), based in each case on the solids content, were mixed together.

This composition was applied with a coat weight of 300 g/m² to a 127 μm Kapton 500HN film from DuPont in a coating process with a drying temperature of 110° C., so that the crosslinking reaction did not commence.

The layer material produced in this way is nontacky and shows no tendency to flow, which also was not to have been expected in view of the physical crosslinking of the block-copolymeric synthetic rubber. Consequently there ought to be virtually no limit to the storage stability of a roll at room temperature.

Test A indicated a shear stress which exceeded the measurement range of the instrument and was therefore more than 50 000 Pa.

Test B showed a complex viscosity eta* for a frequency of 0.01 s⁻¹ and an application temperature of 200° C. of 10 Pas.

The layer material was applied to a prestructured wafer surface with bumps. This wafer was already coated with a release layer, approximately 50 nm thick, of AK 50 type silicone oil from Wacker-Chemie. Under a vacuum press, the adhesive tape was pressed with a pressure of 100 kPa. For this operation the press was heated to a temperature of 200° C. and so the material underwent crosslinking.

When the layer material was removed from the wafer, it exhibited sufficient cohesion and so could be removed without residue.

Test C was used to investigate the temperature stability after crosslinking. Incipient degradation was apparent only from a temperature of 310° C.

### EXAMPLE 6

A mixture of 85% of Kraton™ FG 1901 (maleic anhydride-modified styrene-ethylene/butylene-styrene block copolymer with 30% block polystyrene and approximately 2% maleic anhydride) and 15% of Epofriend™ A 1010 (epoxidized styrene-butadiene-styrene block copolymer with 40% block polystyrene) was dissolved in toluene.

This composition was applied with a coat weight of 300 g/m² to a 127 μm Kapton 500HN film from DuPont in a coating process with a drying temperature of 110° C., so that the crosslinking reaction did not commence.

The layer material produced in this way is nontacky and shows no tendency to flow, which also was not to have been expected in view of the physical crosslinking of the block-copolymeric synthetic rubber. Consequently there ought to be virtually no limit to the storage stability of a roll at room temperature.

Test A indicated a shear stress which exceeded the measurement range of the instrument and was therefore more than 50 000 Pa.

Test B showed a complex viscosity eta* for a frequency of 0.01 s⁻¹ and an application temperature of 200° C. of 10 Pas.

The layer material was applied to a prestructured wafer surface with bumps. This wafer was already coated with a release layer, approximately 50 nm thick, of AK 50 type silicone oil from Wacker-Chemie. Under a vacuum press, the adhesive tape was pressed with a pressure of 100 kPa. For this operation the press was heated to a temperature of 200° C. and so the material underwent crosslinking.

When the adhesive tape was removed from the wafer, it exhibited sufficient cohesion and so could be removed without residue.

Test C was used to investigate the temperature stability after crosslinking. Incipient degradation was apparent only from a temperature of 340° C.

### EXAMPLE 7

### Comparative Example

The adhesive tape from Example 1 was used.

The adhesive tape was applied to a prestructured wafer surface with bumps. The wafer was in this case not coated with a release agent. Under a vacuum press, the adhesive tape was pressed with a pressure of 100 kPa. For this operation the press was heated to a temperature of 160° C. and so the material underwent crosslinking.

The removal of the layer material from the wafer was not possible by hand.

### EXAMPLE 8

The adhesive tape from Example 1 was used. The liner was removed. The surface of the silicone composition was coated in an engraved-roll application process with a dispersion of 15% silica nanoparticles in methoxypropyl acetate (Nanopol XP21/1264 from Hanse-Chemie) and dried at 100° C. The wet coat weight was 0.5 g/m².

The surface thereafter was no longer tacky.

The layer material was applied to a prestructured wafer surface with bumps. The wafer was in this case not coated with a release agent. Under a vacuum press, the adhesive tape was pressed with a pressure of 100 kPa. For this operation the press was heated to a temperature of 160° C. and so the material underwent crosslinking.

Test A continued to show a yield point for the composition of 2400 Pa.

Test B showed a complex viscosity eta* at a frequency of 0.01 s⁻¹ and an application temperature of 130° C. of 30 000 Pas.

The removal of the layer material from the wafer was not possible by hand.

This example shows that it is advantageously possible to integrate a separation layer into the layer material.

1. A process for the temporary fixing of a polymeric layer material on a rough surface, wherein said polymeric layer material comprises at least one viscoelastic layer with the following properties:
exhibiting a shear stress of at least 1000 Pa in a shear stress ramp test at a temperature of 20° C. with a shear stress ramp of 100 Pa/min, without viscoelastic material in the viscoelastic layer beginning to flow,
exhibiting a complex viscosity eta* of less than 50 000 Pas in an oscillatory shear experiment (DMA) at an application temperature and at a frequency of 0.01 s⁻¹,
exhibiting a capacity to increase cohesion and thus lower fluidity when the viscoelastic layer is crosslinked,
exhibiting at least partial elastomeric character after crosslinking for subsequent separation from a surface without residue after crosslinking,
said process comprising the following steps:
first placing the layer material on the rough surface,
introducing energy to lower the viscosity of the at least one viscoelastic layer so that there is flow onto the rough surface, and
crosslinking the layer to give a layer having at least partial elastomeric character that at least partly wets the rough surface.

2. The process for the temporary fixing of a polymeric layer material on rough surfaces of claim 1, which further comprises adding fillers and achieving a shear stress of at least 1000 Pa in the shear stress ramp test.

3. The process for the temporary fixing of a polymeric layer material on rough surfaces of claim 1, which further comprises forming a gel network within the polymeric layer material and achieving a shear stress of at least 1000 Pa in the shear stress ramp test.

4. The process for the temporary fixing of a polymeric layer material on rough surfaces of claim 1, which further comprises raising the temperature and/or applying shearing forces and/or extensional forces in order to lower the viscosity during the application.

5. The process for the temporary fixing of a polymeric layer material on rough surfaces of claim 4, which further comprises applying the shearing forces and/or extensional forces oscillatingly.

6. The process for the temporary fixing of a polymeric layer material on rough surfaces of claim 1, which further comprises pressing in order to support the flow onto the rough surface.

7. The process for the temporary fixing of a polymeric layer material on rough surfaces of claim 1, wherein the at least one viscoelastic material has a degree of crosslinking which corresponds at least to a gel value of 50%.

8. The process for the temporary fixing of a polymeric layer material on rough surfaces of claim 1, which further comprises admixing crosslinkers and/or crosslinking promoters to the viscoelastic material.

9. The process for the temporary fixing of a polymeric layer material on rough surfaces of claim 1, wherein the viscoelastic layer possesses a thickness of more than 100 μm.

10. The process for the temporary fixing of a polymeric layer material on rough surfaces of claim 1, wherein the at least one viscoelastic layer, measured by test C, is resistant for at least one hour to a temperature of more than 200° C.

11. The process for the temporary fixing of a polymeric layer material on rough surfaces of claim 1, wherein the layer material comprises at least one further layer which covers the viscoelastic layer on at least one side and serves as a release liner which is removed at least on one side prior to application to the rough surface.

12. The process for the temporary fixing of a polymeric layer material on rough surfaces of claim 1, wherein the layer material comprises a layer which serves as a permanent carrier of the viscoelastic layer.

13. The process for the temporary fixing of a polymeric layer material on rough surfaces of claim 1, wherein the layer material comprises a release mechanism in relation to the rough surface.

14. The process for the temporary fixing of a polymeric layer material on rough surfaces of claim 1, which further comprises detaching the layer material from the rough surface after processing.

15. The process for the temporary fixing of a polymeric layer material on rough surfaces of claim 1, wherein the rough surface is a frontside or a backside of a wafer.

16. A process for processing a wafer having a frontside and a backside, comprising the following steps:
applying a layer assembly comprising at least one viscoelastic layer to the frontside,
lowering the viscosity of the at least one viscoelastic layer in the layer assembly by introducing energy, so that there is flow onto the wafer's frontside and hence an at least partial physical bond thereto takes place,
crosslinking of the at least one viscoelastic layer, and
thinning and/or coating and/or treatment of the wafer's backside.

17. The process for processing a wafer of claim 16, wherein the introduction of energy and the flow of the layer material onto the wafer surface take place in a bonding press.
